(19) United States
(12) Patent Application Publication
(10) Pub. No.: US 2011/0242304 A1
(43) Pub. Date: Oct. 6, 2011

(54) BIOMETERIC AUTHENTICATION APPARATUS

(76) Inventor: Kenji ICHIGE, Yokohama (JP)

(21) Appl. No.: 13/075,246

(22) Filed: Mar. 30, 2011

(30) Foreign Application Priority Data
Mar. 31, 2010 (JP) 2010-080109

(51) Int. Cl. H04N 7/18

(52) U.S. Cl. 348/77; 348/E07.085

(57) ABSTRACT

A biometric authentication apparatus, for enabling to detect a counterfeit when counterfeited information is inputted, thereby preventing from a mischievous authentication, comprises: a registration unit for register a biometric information pattern; a lighting unit for irradiating a lighting upon a photographing target; an image sensor for photographing the photographing target, upon which the lighting is irradiated by the lighting unit; an authentication process unit for extracting the biometric information pattern from a video signal, being outputted from the image sensor, and thereby comparing it to a biometric information pattern, being registered in the registration unit; and a control unit for controlling a lighting intensity of the lighting irradiated by the lighting unit, wherein the control unit changes the lighting intensity of the lighting irradiated by the lighting unit, and determines on whether the photographing target is a living body or not, with using the change of brightness of the video signal outputted by the image sensor.

This application relates to and claims priority from Japanese Patent Application No. 2010-080109 filed on Mar. 31, 2010, the entire disclosure of which is incorporated herein by reference.

### BACKGROUND OF THE INVENTION

The present invention relates to a biometric authentication apparatus for identifying a person, individually, with using biometric information therein.

In the Patent Document 1, for the purpose of providing an emergency notifying means, being low both in a risk of malfunction of an authentication apparatus and in a risk of being sensed from other people, when a state of emergency is generated, for example, a key is opened with threats or intimidation in a place where a personal authentication is required, etc., there is disclosed a personal authentication apparatus, for executing an emergency notification, by starting a rescue mode, when a vein pattern is indisposed, actively, or when a switch, as a trigger of start of authentication, is pushed down for a longer time than a predetermined time-period, or with using a rotating movement of a finger, etc.

<Prior Art Documents>

<Patent Documents>

[Patent Document 1] Japanese Patent Laying-Open No. 2004-110605 (2004).

### BRIEF SUMMARY OF THE INVENTION

A finger vein authentication apparatus is a biometric authentication apparatus, for authenticating or identify a person, individually, while registering a vein pattern of a finger of a person, as biometric information, in advance, by executing a comparison process between a vein pattern of a finger presented to that registered. The finger vein authentication apparatus is also put into a practical use, as the biometric authentication apparatus of ATM of a bank, and it achieves a high security, which is demanded for the personal authentication apparatus in a financial transaction. As other examples of practical use thereof, there are cases where it is applied into an entering/leaving management apparatus for a company or an office, handing information of a high privacy or concealment, and where it is applied into a user authenticating means for an information apparatus, such as, a personal computer, etc.

Such a group of products mentioned above is only for a business use; however in future, it is expected to be put into the practical use of a product of a personal level. Thus, it can be assumed to be manufactured as a group of products for a personal use, and also assumed to be used by a large number of users at various places. Then, a matter, as a problem to be dissolved herein, is a countermeasure for a hacking, i.e., cheating the authentication apparatus with bad faith.

For example, since the finger vein authentication apparatus authenticates a person, individually, by executing a comparison of the vein pattern of the finger, therefore, on the vein pattern to be registered is taken a measure for not being stolen, such as, through an encryption, etc. However, if a picture under photographing is imitated or counterfeited by any kind of means, there is still a very small possibility that the authentication is made mischievously, as the person her/himself. If a person who has knowledge relating to a camera signal process purchases an authentication apparatus on a market, and disassembles and analyzes it, etc., technically, it is possible for her/him to identify the processing route of video signal, and thereby to flow that imitated or counterfeited video signal therein, in the place of the inherent or proper video signal photographed. If the authentication apparatus for the personal use is sold on the market, it means that chances for trying such doing as mentioned above increases.

The present invention has an object to provide a biometric authentication apparatus for enabling to detect such counterfeit, even if the counterfeited information is inputted therein, and thereby preventing it from a mischievous authentication thereof.

According to the present invention, the object mentioned above is accomplished by the invention, which is described in the claims.

According to the present invention, it is possible to provide a biometric authentication apparatus for enabling to detect such counterfeit, even if the counterfeited information is inputted therein, and thereby preventing it from a mischievous authentication thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an example of a finger vein authentication apparatus;

FIG. 2 is a flowchart for showing an example of a lighting control process; and

FIG. 3 is a flowchart for showing an authentication process.

### DETAILED DESCRIPTION OF THE PREFERRED EMBODIMENTS

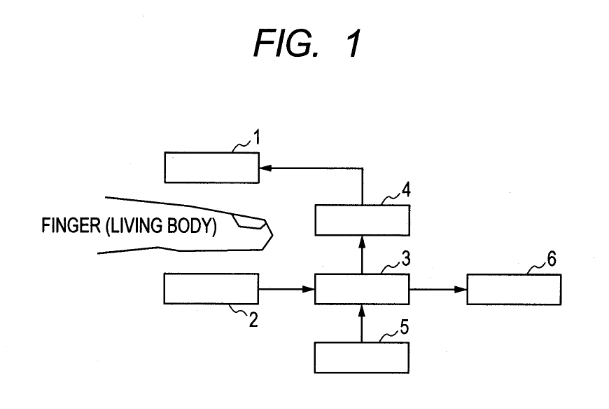

FIG. 1 is a block diagram for showing an example of a finger vein authentication apparatus, wherein a reference numeral 1 depicts a lighting unit, 2 an image sensor, 3 an authentication process unit, 4 a lighting control unit, 5 a template storage memory, and 6 a host interface, respectively.

The lighting unit 1 is a portion for irradiating lights necessary for photographing of a finger vein, and is constructed with an infrared LED, etc . A finger of human being transmits inferred light therethrough, and a part of that light is absorbed by a vessel portion of the vein; therefore, it appears as light and shade on a picture. The image sensor 2 is an optical sensor for imaging the light transmitting through the finger, and herein is used a sensor having sensitivity in a region of infrared light. As an output, a video signal or picture data is outputted, on which the finger vein appears in the form of a pattern thereof (i.e., a finger vein pattern).

The authentication process unit 3 is a portion for processing the video signal, including the finger vein pattern therein, and for executing the authentication process, therefore it includes a processing unit for executing those processes therein. Also, the authentication process unit 3 functions to transmit information necessary of a flashing process, to the lighting control unit 4, which controls the lighting unit 1 mentioned above.

The lighting control unit 4 is a portion for controlling the flashing in the lighting unit 1. The lighting control unit 4 determines a lighting level and drives the lighting unit 1. Also, the lighting control unit 4 feeds an operation result of the flashing control back to the authentication process unit 3, thereby giving the information in relation to whether the video signal inputted is counterfeited or not.

The template storage memory is a memory for storing or reserving the registered finger vein pattern therein, i.e., the authentication process unit 3 reads a registered pattern therein, depending on a necessity thereof, and executes a comparison process. In this manner, the present embodiment is an example of a self authentication method, in which the finger vein pattern is reserved in an inside of the apparatus, and the comparison process is executed with this. Since leakage of this vein pattern into an outside brings about an enormous damage on the security of the personal information, it is reserved as data, upon which an encryption process is treated.

The host interface 6 is an interface for executing communication between a host system, with which the present apparatus is connected, and as an example of implementation, there can be considered a USB (Universal Serial Bus) standard, which is used, widely, in a personal computer and peripheral apparatuses thereof. The authentication result of the present apparatus is transmitted to the host, passing through the host interface 6, and the host executes an operation depending on the authentication result. When executing data transmission between the host interface 6 and the host, authentication is made, mutually, that the other party is an appropriate apparatus, and a part of or all of the data is encrypted to be transmitted; thereby enabling to execute an implementation with increasing a safety thereof.

In the present example, determination is made on whether the video signal inputted is counterfeited or not upon operation of the lighting control unit 4, and if it is determined to be counterfeited (i.e., imitation), then an operation is made as the authentication is failed. This is made upon based of a fact a brightness of the picture reflecting is also changed when changing a brightness of the lighting.

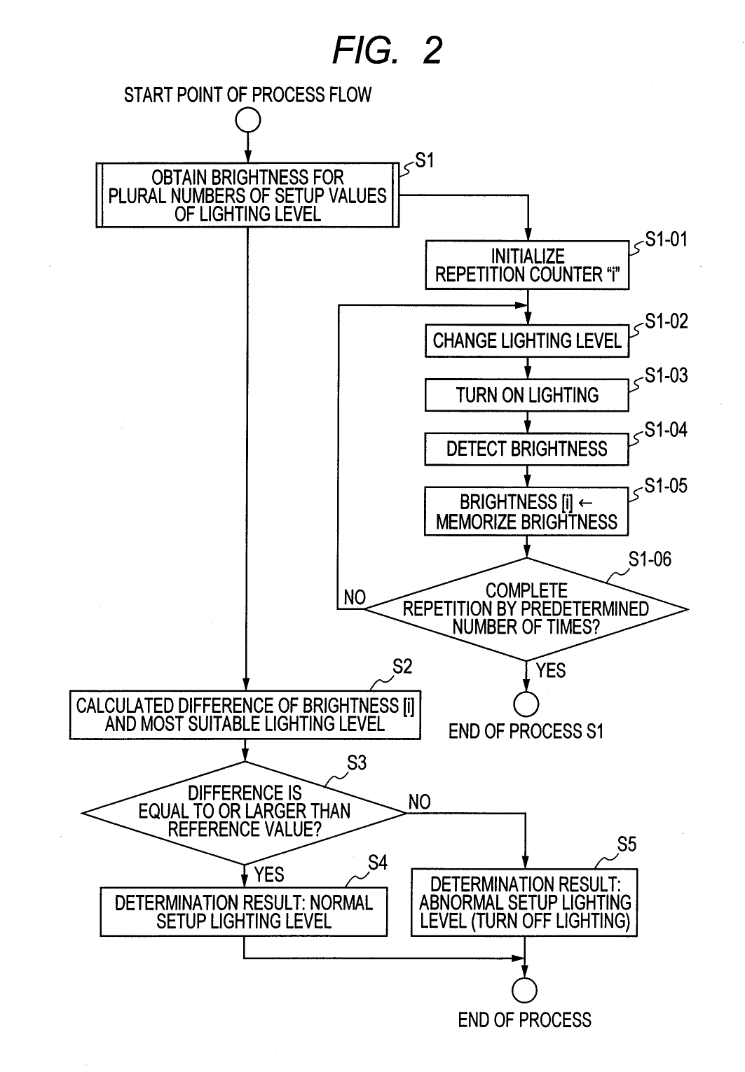

FIG. 2 is a flowchart for showing an example of a lighting control process in the lighting control unit 4, wherein there are shown processing steps S1 to S5, and are also shown steps S1-01 to S1-06, which build up the step S1.

A step S1 is a process for obtaining brightness of the video signal, with respect to plural numbers of predetermined setup values of lighting levels. There is necessity of determining at least two (2) sets of setup values, differing from each other in the lighting levels thereof. The lighting control unit 4 determines the lighting level of the lighting unit 1, and measures the brightness of the picture, which is photographed while irradiating the light upon an actual finger. Detailed processes herein will be mentioned later.

A step S2 is a process for calculating differences thereof, from plural numbers of data of the brightness, which are obtained in the step S1, and thereby estimating a most suitable lighting level determination through an interpolation process. A step S3 a conditional branching for determining on whether change much more than a reference value appears or not, by comparing the difference obtained in the step S3 with that reference value.

If there is the difference exceeding the reference value, then it is determined that the actual finger is photographed, and a result of determination is made normal (step S4). On the other hand, if the difference is lower than the reference value, then it is determined that the video signal as an input is counterfeited, or that there is an abnormality therein, and then the result of determination is made abnormal (step S5).

In the step S4, the most suitable value of the lighting level obtained in the above is determined, and the lighting is turned on. In the step S5, it is determined to be abnormal, and then the lighting is turned off while determining the photographing is unnecessary.

About the reference value mentioned above, there can be considered that it is changed, adaptively, by taking an influence of an external light into the consideration thereof. Thus, it is the case where the light irradiating upon the finger is that emitting from other than the lighting unit 1, i.e., including the external light therein. In this case, since it can be assumed that the brightness of the video signal has a constant offset, then the reference value is changed by detecting this. With this, it is possible to make the determination, correctly, much more.

Details of the steps S1-01 to S1-06 of the step S1 will be mentioned, hereinafter.

In a step S1-01 is initialized a repetition counter “i”, and in a step S1-02 is changed the lighting level to one of the plural numbers of setup values. In a step S1-03, the lighting is turned on, and in a step S1-04, detection is made on the brightness of the video signal, and then in a step S1-05, the brightness obtained for each setup of the lighting level is recorded. Depending on the conditional branching of a step S1-06, a processing flow for obtaining the brightness, i.e., the steps from S1-02 to S1-05, will be repeated.

For detection of the brightness of the video signal in the step S1-04, plural numbers of implementation methods are applicable; such as, a method for obtaining it, as the data relating the brightness, via the authentication process unit 3, while executing it as a part of the processing for the image sensor, or a method of transmitting a result of calculation of the brightness, which is calculated by processing video signal obtained by the authentication process unit 3, to the lighting control unit 4, for example.

The processes of S1-01 to S1-06 mentioned above build up the processing of the step Sl.

By means of a process flow of the lighting control unit 4 shown in the above, it is possible to execute the flashing control of the lighting unit 1, as well as, to obtain the result of determination on whether the video signal inputted is counterfeited or not.

Next, explanation will be made on a process flow of the authentication process unit 3, combining with the process of the lighting control unit 4 mentioned above.

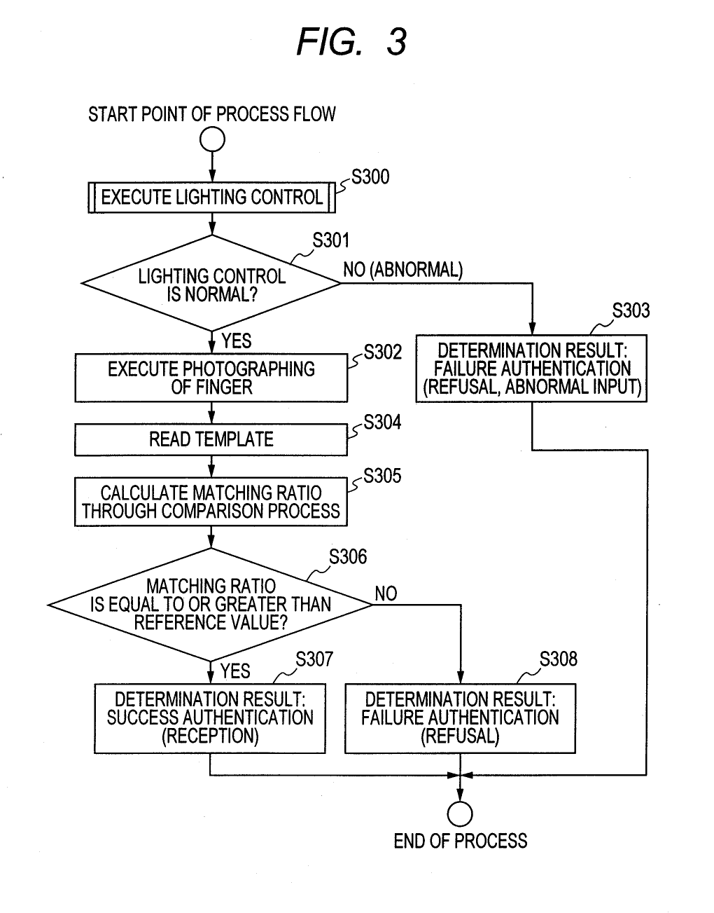

FIG. 3 is a flowchart for showing an example of the authentication process within the authentication process unit 3, and it is built up with processing steps S300 to S308.

Hereinafter, explanation will be made on each processing step, one by one, in the order thereof. Ina step S300, the lighting control is executed. This process includes the processing flow of the lighting control unit 4 in the contents thereof, and as a result thereof, there can be obtained the operation of the flashing control and the result of determination the lighting control.

The conditional branching of a step S301 is a branching process upon basis of the result of determination of the lighting control. If the result of determination is that the lighting control is normal, then the photographing processes after the step S3 will continue. If it is determined to be abnormal, then an error processing after the step S303 will continue.

In a step S302, the photographing is executed, and in a step S304 is read in a registered template, and then in a step S305, calculation of a matching ratio is executed with the comparison process. Herein, the matching ratio is a numerically presented degree of matching, being obtained through the comparison process of the vein patterns, which are extracted from the registered template and the input video signal, in the form of the video data thereof. If a matching ratio can be obtained, being equal to or higher than a certain reference value (which is a predetrermined value), it is determined that the authentication is succeeded (i.e., it is the person itself).

Ina step S306, when the matching ratio is equal to or higher than the reference value, after comparing it to the reference value, then, in a processing step S307, a result of determination is that the authentication is succeeded (reception). On the other hand, when it does not reach the reference value, in a processing step S308, the result of determination is that the authentication is failed (refuse).

From the processing flow mentioned above, a result of authentication can be obtained, and that result is transmitted to the host, passing through the host interface 6.

As was mentioned in the above, according to the present example, in case where a counterfeited video signal is inputted through changing an input route of the video signal into the finger vein authentication apparatus, it is possible to detect a fact of the counterfeit through the lighting control, and thereby determining that the authentication is failed. With this, it is possible to achieve the authentication apparatus for enabling to increase reliability thereof much more. Also, since the means for detecting the counterfeit mentioned above can be constructed with, without adding a special sensor thereto, therefore, it is possible to achieve it without accompanying cost-up.

However, although the explanation was given on the example of the biometric authentication apparatus with using the information relating to the finger vein, as the biometric information; however, the present invention should not be restricted only to this, and it may be applied in a case of using the vein of a part other than the finger, such as, the vein of a palm, for example, or maybe applied in a case of using the biometric information of, but other than that of the vein.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A biometric authentication apparatus, comprising:
a registration unit, which is configured to register a biometric information pattern;
a lighting unit, which is configured to irradiate a lighting upon a photographing target;
an image sensor for photographing the photographing target, upon which the lighting is irradiated by said lighting unit;
an authentication process unit, which is configured to extract the biometric information pattern from a video signal, being outputted from said image sensor, and thereby to compare it to a biometric information pattern, being registered in said registration unit; and
a control unit, which is configured to control a lighting intensity of the lighting irradiated by said lighting unit, wherein
said control unit changes the lighting intensity of the lighting irradiated by said lighting unit, and determines on whether said photographing target is a living body or not, with using the change of brightness of the video signal outputted by said image sensor.

2. A biometric authentication apparatus, comprising:
an image sensor, which has a sensitivity within a wavelength region of infrared light;
a lighting unit, which is configured to photograph a part of a living body by said sensor;
a lighting control unit, which is configured to control a lighting intensity by said lighting; and
an authentication process unit, which is configured to extract a vein pattern of an inside of a living body from a video signal, being obtained by said image sensor, and thereby to execute a comparison process with registered data, wherein
said lighting control unit includes processes of changing the lighting intensity, before photographing a living body, detecting a change of brightness of the video signal, which is obtained by said image sensor, and then determining presence/absence of counterfeit of the video signal, upon basis of largeness of this change.

3. The biometric authentication apparatus, as described in the claim 2, wherein the part of the living body, which is photographed by said sensor, is a finger.
